(19) United States
(12) Patent Application Publication
(10) Pub. No.: US 2016/0102690 A1
(43) Pub. Date: Apr. 14, 2016

(54) RIG AND SURFACE MAT LOCKING MECHANISM

(71) Applicant: Rhinokore Composites Manufacturing Partnership, Armstrong (CA)

(72) Inventor: Lawrence Alexander Hruschak, Sherwood Park (CA)

(21) Appl. No.: 14/875,212

(22) Filed: Oct. 5, 2015

Related U.S. Application Data
(60) Provisional application No. 62/061,942, filed on Oct. 9, 2014.

(51) Int. Cl. F16B 5/00

(52) U.S. Cl. CPC F16B 5/0092

(57) ABSTRACT

A locking mechanism to secure together a pair of adjacent panels in a side by side, generally co-planar, relationship. The locking mechanism comprises a receiver securable to one of the panels and a rotor securable to the other of the panels. The rotor is rotatably engageable with the receiver to draw together and to lock the panels together so as to limit separation therebetween. The receiver permits vertical deflection of the rotor when the rotor is engaged with the receiver thereby permitting one of the panels to be inclined relative to the other without separation of the panels.

### CROSS-REFERENCE TO RELATED APPLICATION

This application claims priority to U.S. Provisional Patent Application Ser. No. 62/061,942, filed Oct. 9, 2014, which is herein incorporated by reference.

### BACKGROUND OF THE INVENTION

1. Field of the Invention.

This invention relates generally to the field of rig mats or other panel members, and in particular to a locking mechanism for rig mats and similar structures.

2. Prior Art.

Rig mats of various sorts have been used for decades for purposes of providing a stable base or footing upon which equipment or structures can be mounted, driven or moved, in cases where the underlying ground formation is soft or otherwise insufficient to support the load to which it would otherwise be subjected. Rig mats are also sometimes used in ecologically sensitive areas to form a roadway or base so as to not unduly disturb the underlying ground structure. Early rig mats typically comprised a series of logs that were lashed or otherwise fastened together. More recently, a wide variety of alternate structures and materials have been used as rig mats, typically formed in large planar, sheet-like, panels. Individual sheets or mats may be formed from wood, steel, a variety of different composite materials, etc. In the case of northern climates where it may be necessary or advisable to maintain the underlying soil structure in a frozen state, individual mats may have a foam core to add an insulating factor. When in use, a number of rig mats (or road mats as they are sometimes referred to) are typically placed side by side and/or end to end, in order to form a roadway, a base, or foundation.

Once in position, it is important that the mats be held together and not shift significantly during use, to the extent that openings or gaps are formed between adjacent mats. If gaps were to form, vehicles could potentially become stuck (particularly where the mats are used over soft or swampy terrain) and/or damage could occur to ecologically sensitive ground formations.

To prevent a shifting of the mats during their use, others have provided a variety of different locking mechanisms that hold the mats generally in place. Such mechanisms have included the use of bolts, pins, hinge-type structures, cables, etc. The locking mechanisms between adjacent mats must not only prevent the mats from shifting relative to one another, but should also allow a degree of flexure between adjacent mats, particularly where the mats are placed over uneven terrain, or where the underlying surface is soft or swampy. That is, as a vehicle passes over a mat and approaches an adjacent mat, the underlying terrain may be such that a degree of angular displacement or tipping of one mat occurs relative to the adjacent mat. The locking mechanisms must not only accommodate such a tipping motion, but must also reduce or eliminate the tendency of the mats to separate when tipped in such a fashion. Unfortunately, many of the currently utilized locking structures do not readily accommodate tipping between adjacent panels, are mechanically complex, can be prone to breakage or to becoming jammed on account of the infiltration of dirt and/or ice, and/or can be laborious to install and remove.

### SUMMARY OF THE INVENTION

Accordingly, in one of its aspects the invention provides a locking mechanism to secure together a pair of adjacent panels in a side by side, generally co-planar, relationship, the locking mechanism comprising a receiver securable to one of the panels and a rotor securable to the other of the panels, said rotor rotatably engageable with said receiver to draw together and to lock the panels together so as to limit separation therebetween, said receiver permitting vertical deflection of said rotor when said rotor engaged with said receiver thereby permitting one of the panels to be inclined relative to the other without separation of the panels.

In a further aspect the invention provides a pair of generally planar panels, said panels including a locking mechanism to secure said panels together in an adjacent generally co-planar relationship, the locking mechanism comprising a receiver securable to one of the panels and a rotor securable to the other of the panels, said rotor rotatable about an axis that is generally perpendicular to the plane of the panel to which it is secured, said rotator rotatably engageable with said receiver such that the engagement of said rotor with said receiver draws together and locks together the panels limiting separation therebetween while permitting a deflection of said rotor within said receiver and allowing one of said panels to be inclined relative to the other without separation of the panels.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a plan view of four rig mats positioned adjacent to one another and incorporating a locking system in accordance with an embodiment of the present invention.

FIG. 2 is a view similar to FIG. 1 wherein the adjacent mats have been locked together.

FIG. 3 is an enlarged detail view of portion “A” of FIG. 1.

FIG. 4 is a vertical sectional view taken along the line 4-4 of FIG. 3.

FIG. 5 is an enlarged detail view of portion “F” of FIG. 4.

FIG. 6 is an enlarged detail view of portion “B” of FIG. 1.

FIG. 7 is a vertical sectional view taken along the line 7-7 of FIG. 6.

FIG. 8 is an enlarged detail view of portion “C” of FIG. 2.

FIG. 9 is a vertical sectional view taken along the line 9-9 of FIG. 8.

FIG. 10 is a vertical sectional view taken along the line 10-10 of FIG. 8.

FIG. 11 is a vertical sectional view taken along the line 11-11 of FIG. 8.

FIG. 12 is an enlarged detail view of portion “D” of FIG. 2.

FIG. 13 is a vertical sectional view taken along the line 13-13 of FIG. 12.

FIG. 14 is an enlarged detail view of portion “E” of FIG. 2.

FIG. 15 is a vertical sectional view taken along the line 14-14 of FIG. 14.

FIG. 16 is a plan view of the lock rotor in accordance with an embodiment of the invention.

FIG. 17 is a side elevational view of the lock rotor of FIG. 16.

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

The present invention may be embodied in a number of different forms. The specification and drawings that follow describe and disclose some of the specific forms of the invention.

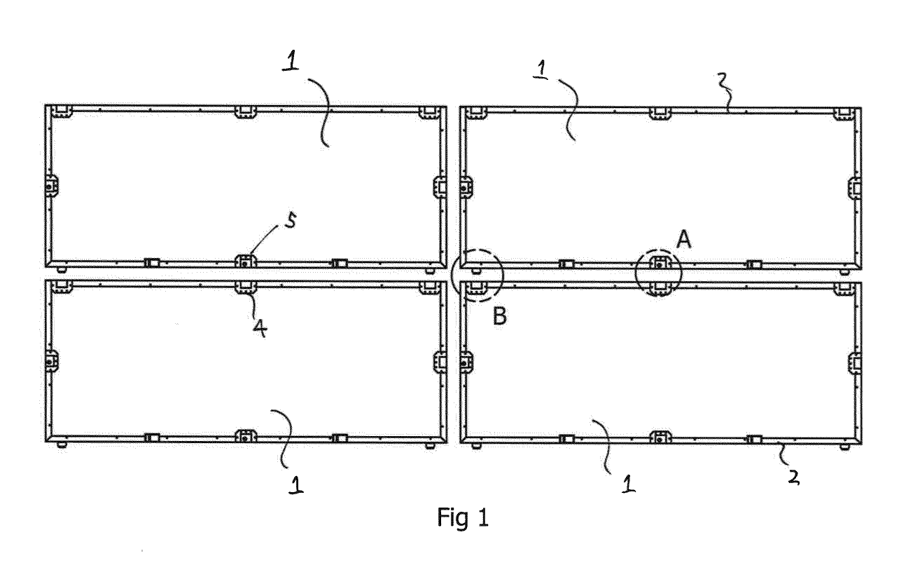

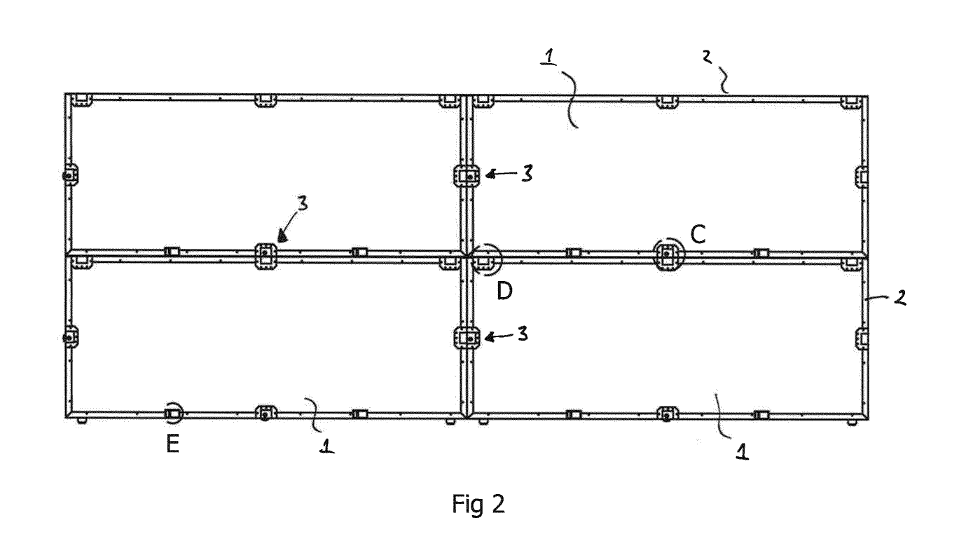

The enclosed drawings depict an embodiment of the invention wherein a locking mechanism is used to secure together a number of adjacent panels in a side by side, generally co-planar, relationship. In the drawings, the panels are referred to generally by reference numeral 1 and may be any one of a wide variety of different forms of panels that can, or are typically, used for purposes of rig mats, road mats, equipment bases, foundations, etc. In the particular embodiment shown in the drawings, panels 1 are rectangular panels formed from composite materials having a steel or other similarly rigid frame 2. FIG. 1 shows four such panels in a spaced-apart, co-planar, relationship. In FIG. 2, the panels have been secured together using a locking mechanism 3 constructed in accordance with an embodiment of the invention.

Pursuant to the invention, locking mechanism 3 comprises a receiver 4 securable to one of the panels and a rotor 5 securable to a second panel. In the embodiment shown, rotor 5 is positioned within a rotor housing 50, that itself is mounted within an edge of a panel 1. Similarly, receiver 4 includes a receiver housing 51 mounted within an edge of a panel. In operation, rotor 5 will have a disengaged position where it is received fully within housing 50. Rotor 5 is rotatable to an engaged position where a portion of the rotor extends outwardly from housing 50 and is rotatably engagable with receiver 4 to draw, and to lock, the panels together so as to limit separation between the respective panels, and to maintain them in a generally co-planar relationship. As will become apparent from the following description, receiver 4 also permits a vertical deflection of rotor 5 when it is engaged with the receiver to permit one of the panels to be inclined or tipped relative to the other without separation.

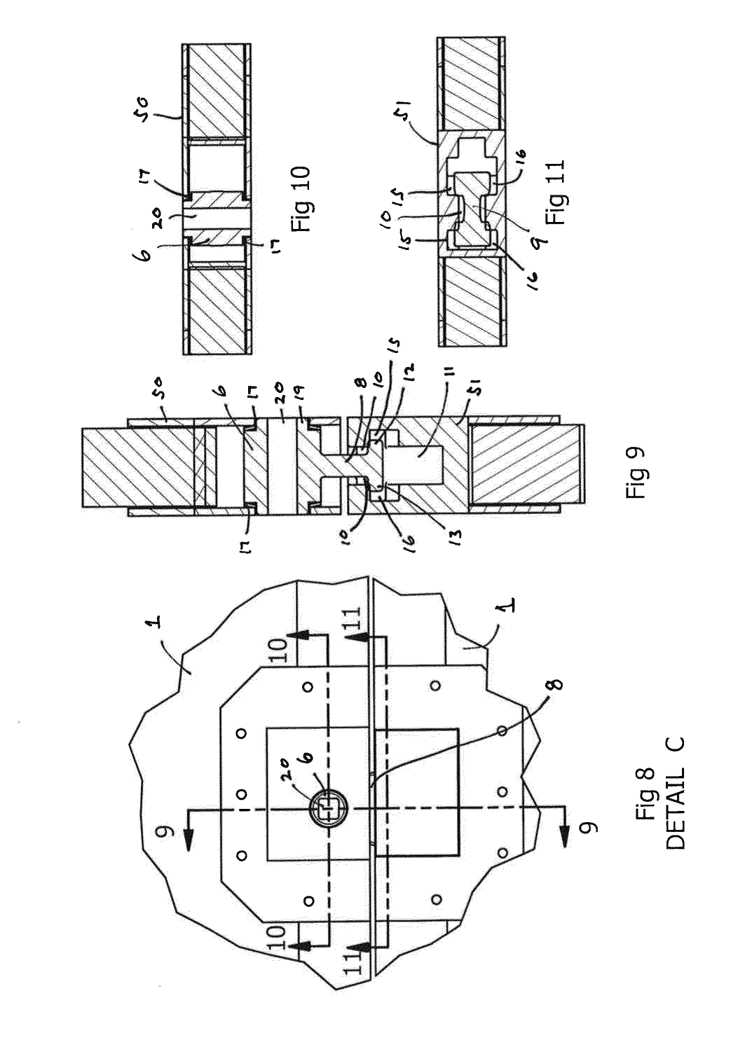

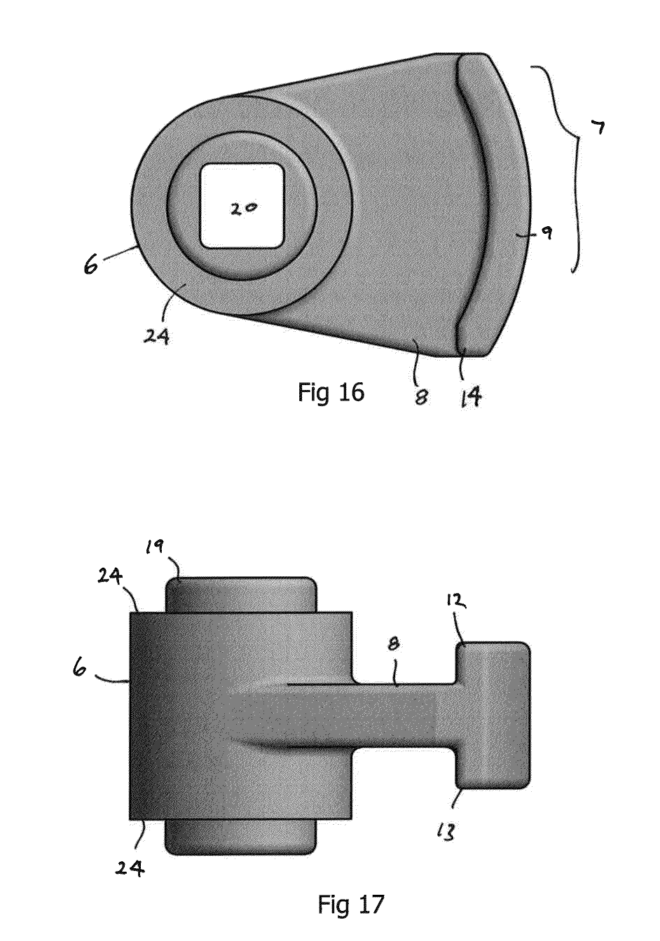

In general, rotor 5 is comprised of an axle member or portion 6 and an engagement member 7 that is secured to the axle member by a web 8. The axle member is mounted within one of panels 1 such that it is generally perpendicular to the principal plane of the panel and rotatable therewith. In the attached drawings axle member 6 is mounted within rotor housing 50 with its axis of rotation generally perpendicular to the principal plane of the panel. Web 8 intersects axle member 6 at approximately 90° (see FIG. 17) such that rotation of rotor 5 about the longitudinal axis of the axle member causes engagement member 7 to be rotated in a plane that is generally co-planar with panel 1. Engagement member 7 is comprised of curved or sloped surface 9 that engages, or is received by, an operatively configured surface 10 within an internal slot or chamber 11 of receiver 4, causing the panels to be drawn together in a close relationship when the rotor is rotated. That is, with reference to FIGS. 9 and 16 it will be appreciated that in the described embodiment curved surface 9 arches away from axle member 6 (see FIG. 16) and surface 10 is arched to accommodate surface 9 when the rotator is moved to its engaged position (see FIG. 9) so that the movement of surface 9 along surface 10 causes the two adjacent panels to be drawn together.

Surface 9 and web 8 form a generally T-shaped flange with an upper extension 12 and a lower extension 13. Internal slot or chamber 11 is also generally co-planar with the principal plane of panel 1 and can be aligned with rotor 5 when it is desired to secure two adjacent panels together. In the embodiment shown slot 11 is generally T-shaped to accommodate the T-shaped flange of the rotor.

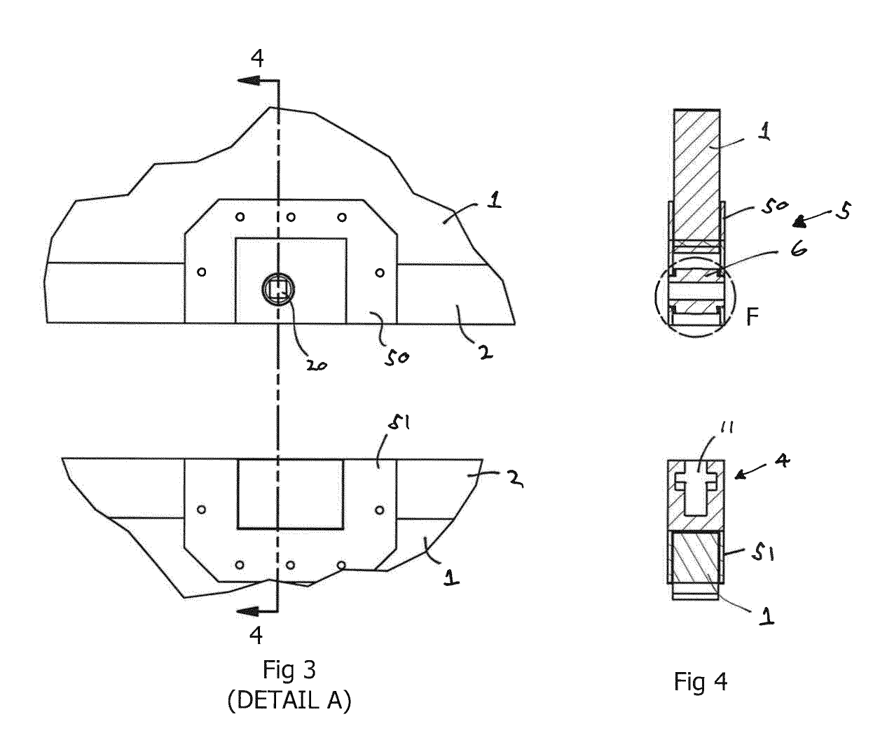

Prior to being secured together, rotor 5 is preferably in its disengaged position wherein engagement member 7 and web 8 are retained fully within rotor housing 25 and within the confines of the panel itself (see FIG. 3). Once the panels are placed side by side with a rotor of one panel in close proximity to a receiver of an adjacent panel, rotor 5 can be rotated to permit engagement member 7 to be received within slot 11 of receiver member 4 on the adjacent panel. The leading edge 14 of extensions 12 and 13 may be rounded in order to facilitate its engagement with receiver 4. As mentioned, so that the panels may be secured together by locking mechanism 3, slot 11 within receiver 4 contains a similarly shaped T-slot having channels 15 and 16 that accept upper and lower extensions 12 and 13. In plan view, channels 15 and 16 will be curved and shaped similarly to extensions 12 and 13 of rotor 5. Thus, rotation of rotor 5 when a corresponding panel having a receiver 4 is placed adjacent to the rotor will enable engagement member 7 to be received within slot 11 of receiver 4 such that upper and lower extensions 12 and 13 are engaged within channels 15 and 16. On account of the curvature of extensions 12 and 13, as the rotor is further rotated it will be appreciated that the panels will be to some degree drawn together into a close and fixed apart distance. In the attached drawings, rotation of the rotor in a clockwise direction causes the rotor to engage the receiver in the manner described above. In one embodiment slot 11 will have an end stop that prevents the rotor from being rotated beyond a position where web 8 extends from rotor housing at approximately 90°.

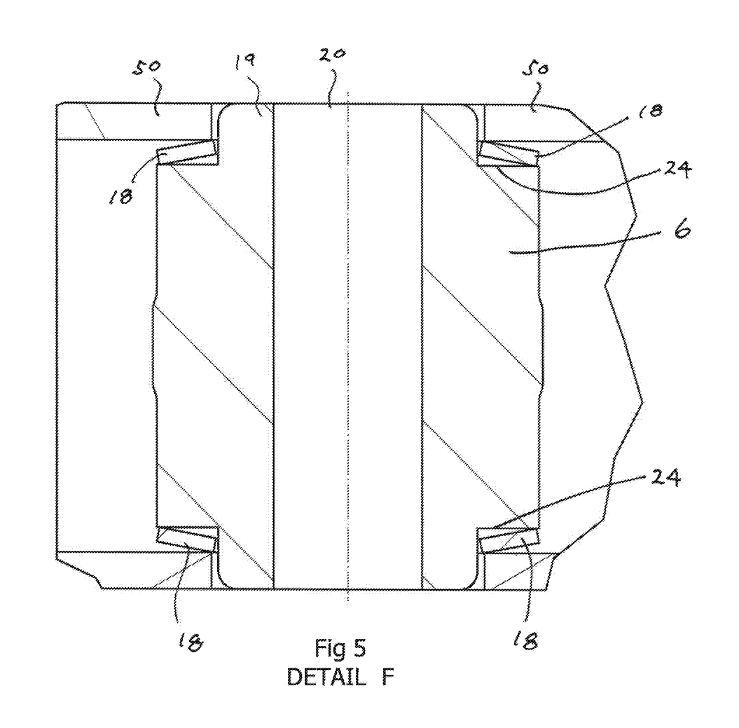

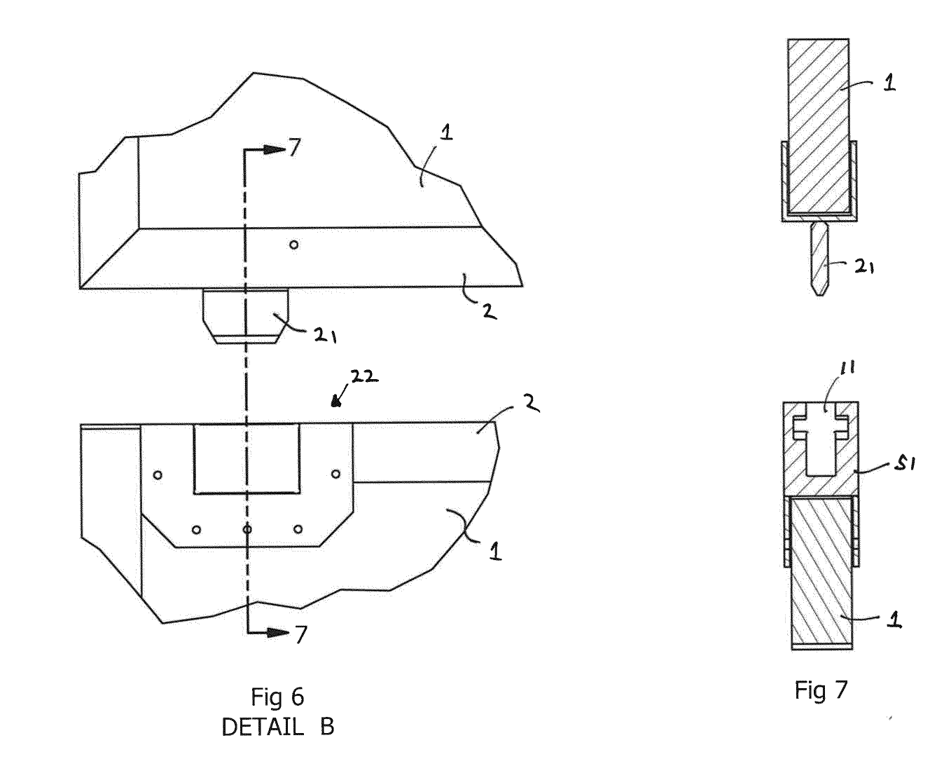

In an embodiment of the invention, locking mechanism 3 further includes biasing means that bias the rotor to a position generally co-planar with the panel to which it is secured. In the particular embodiment shown in the attached drawings, biasing means 17 comprise a pair of springs 18, with one of the springs positioned at each end of axle member 6 extending between a shoulder 24 on the axle member and rotor housing 50. Here, springs 18 are Belleville washers, however, it will be appreciated that a variety of other spring structures could equally be used. When compressed in place (for example see FIG. 5) between the axle member and rotor housing 50 springs 18 will help to maintain the rotor in an orientation such that web 8 is generally co-planar with panel 1. Further, springs 18 will tend to enhance the frictional engagement of the rotor member positioned its housing, minimizing the likelihood that the rotor may unintentionally rotate and become exposed (raising the potential for damage to the rotor) when the panels are being transferred from place to place, or that the rotor may rotate and unlock panels during the movement of equipment etc. over adjacent panels that are secured together. Springs 18 serve the additional function of permitting a degree of flexure within locking mechanism 3. That is, through the incorporation of springs 18 at both the upper and lower ends of axle member 6, rotor 5 is permitted to flex from its position wherein it is generally planar with panel 1 to a position where it is slightly inclined or slightly declined (i.e. tipped).

The ability for the rotor to flex within panel 1, together with dimensional tolerances between extensions 12 and 13 on the rotor and channels 15 and 16 within the receiver, will permit one of the adjacent panels to be inclined relative to the other without separation when the panels are secured together with locking mechanism 3. For example, when equipment is travelling over adjacent locked panels that are positioned over uneven terrain, the weight applied to one panel may tend to force the panel in a downward direction, which would in many instances place considerable force upon the particular locking mechanism at hand, potentially damaging the locking mechanism or causing a separation of the two panels. In the case of locking mechanism 3, the described mechanism permits a vertical deflection of the rotor within the receiver and permits adjacent, locked together, panels to be inclined relative to one another without separation, thereby accommodating the loading and stresses applied through uneven loading on variable terrain.

With particular reference to FIGS. 8 and 16, to facilitate the movement of the rotor from its disengaged to its engaged position, in the embodiment depicted axle portion or axle member 6 has an upper end 19 that is received through the top of housing 50. The upper end of the axle includes an opening 20 for releasably receiving a tool that can be used to rotate the rotor. In most cases it is expected that opening 20 will be dimensioned to receive the end of a ratchet so that engaging the locking mechanism merely requires an assembler to place the end of the ratchet within opening 20 and rotate the rotor to its locked or engaged position.

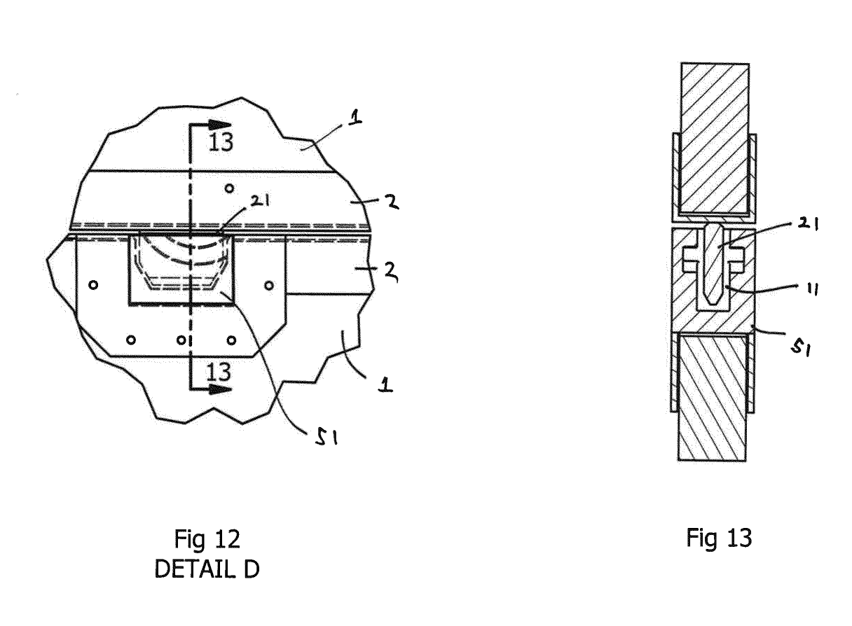

With reference to FIGS. 1, 12 and 13, panels 1 may further include locating pins and locating sockets such that when panels are brought into an adjacent configuration the locating pins can be received within the locating sockets to align the panels in such a way that permits the rotors to be aligned and thereafter engaged with receivers on the adjacent panel. In the particular embodiment shown in FIGS. 12 and 13, locating pins 21 are dimensioned to be accepted into receivers 4. That is, receivers 4 accomplish the dual purpose of either receiving a rotor or a locating pin. It will further be appreciated that a number of rotor and receiver housings may be positioned about the sides of panel 1 to permit locking along side and/or end surfaces at various locations.

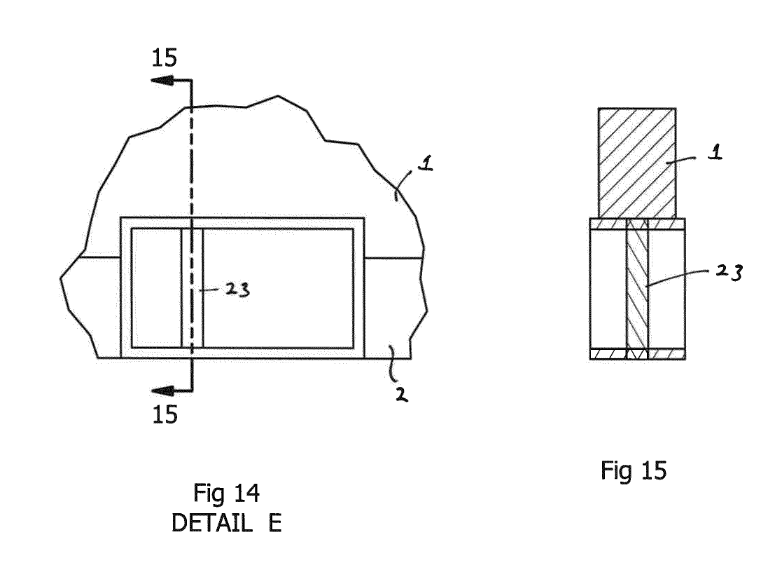

With reference to FIGS. 2, 14 and 15, panel 1 may further include a handle portion 23 which may be grasped, that may accommodate a lifting cable or lifting chain, or beneath which the tine of a forklift could be received in order to assist in lifting the panel from place to place.

It will be appreciated from a thorough understanding of the invention describe above and shown in the attached drawings that there is provided a new and unique method to releasably secure together panels in an adjacent side by side relationship. The described locking mechanism not only secures the panel together but allows for a degree of flexure and inclination of adjacent panels without separation.

It is to be understood that what has been described are the preferred embodiments of the invention. The scope of the claims should not be limited by the preferred embodiments set forth above, but should be given the broadest interpretation consistent with the description as a whole.

What is claimed is:

1. A locking mechanism to secure together a pair of adjacent panels in a side by side, generally co-planar, relationship, the locking mechanism comprising a receiver securable to one of the panels and a rotor securable to the other of the panels, said rotor rotatably engageable with said receiver to draw together and to lock the panels together so as to limit separation therebetween, said receiver permitting vertical deflection of said rotor when said rotor engaged with said receiver thereby permitting one of the panels to be inclined relative to the other without separation of the panels.

2. The locking mechanism as claimed in claim 1 wherein said rotor includes a curved or sloped surface that engages an operatively configured surface within said receiver such that upon the rotation of said rotor, said curved or sloped surface of said rotor engages said operatively configured surface of said receiver causing the panels to be drawn together in a close adjacent relationship.

3. The locking mechanism as claimed in claim 2 wherein said rotor includes biasing means biasing said rotor to an orientation generally co-planar with the panel to which it is secured.

4. The locking mechanism as claimed in claim 3 wherein said biasing means resist rotation of said rotor.

5. The locking mechanism as claimed in claim 4 wherein said rotor includes an axle portion forming an axis of rotation for said rotor, said axle portion generally perpendicular to the plane of the panel to which said rotor is secured such that said rotor rotates in generally the same plane as the panel.

6. The locking mechanism as claimed in claim 5 wherein said biasing means comprises a pair of springs, one of said springs positioned at each end of said axle portion.

7. The locking mechanism as claimed in claim 6 wherein said springs are Belleville washers.

8. The locking mechanism as claimed in claim 7 wherein said curved or sloped surface comprises a generally T-shaped flange and said operatively configured surface is generally T-shaped, the engagement of said flange with said surface restricting the separation of the panels.

9. The locking mechanism as claimed in claim 8 wherein said axle portion has an upper end that is received through the panel when said rotor is secured thereto, said upper end of said axle portion including an opening to releasably receive a tool for rotating the rotor.

10. A pair of generally planar panels, said panels including a locking mechanism to secure said panels together in an adjacent generally co-planar relationship, the locking mechanism comprising a receiver securable to one of the panels and a rotor securable to the other of the panels, said rotor rotatable about an axis that is generally perpendicular to the plane of the panel to which it is secured, said rotator rotatably engageable with said receiver such that the engagement of said rotor with said receiver draws together and locks together the panels limiting separation therebetween while permitting a deflection of said rotor within said receiver and allowing one of said panels to be inclined relative to the other without separation of the panels.

11. The panels as claimed in claim 9 wherein said rotor has a curved or sloped surface that engages a correspondingly configured surface within said receiver such that the rotation of said rotor when engaged with said receiver causes adjacent panels to be drawn together in a close adjacent relationship.

12. The panels as claimed in claim 11 wherein said rotor includes biasing means to bias said rotor into an orientation generally co-planar with the panel to which it is secured.

13. The panels as claimed in claim 12 wherein said biasing means resist rotation of said rotor.

14. The panels as claimed in claim 11 wherein one of said panels includes a locating pin and the other of said panels includes a locating socket, when said panels brought into an adjacent configuration said locating pin received within said locating socket to align the panels and to thereby permit said rotor to be engaged with said receiver.

15. The panels as claimed in claim 11 wherein said rotor includes an axle portion forming an axis of rotation of said rotor, said axle portion generally perpendicular to the plane of the panel to which said rotor is secured such that said rotor rotates in generally the same plane as the panel, said axle portion having an upper end that is received through the panel when said rotor is secured thereto, said upper end of said axle portion including an opening to releaseably receive a tool for rotating the rotor.

16. The panels as claimed in claim 15 wherein said rotor includes a pair of springs, one of said springs positioned at each end of said axle portion, said springs biasing said rotor into an orientation generally co-planar with the panel to which it is secured.

17. The panels as claimed in claim 10 including a plurality of rotors and receivers positioned about the exterior edges said panels.
